(19) United States
(12) Patent Application Publication
(10) Pub. No.: US 2026/0301227 A1
(43) Pub. Date: Oct. 1, 2026

(54) Method for Calibrating a Camera System for a Motor Vehicle

(71) Applicants: Robert Bosch GmbH, Stuttgart (DE); CARIAD SE, Wolfsburg (DE)

(72) Inventors: Fabian Meyer, Stuttgart (DE); Benjamin Resch, Stuttgart (DE); Johannes Berger, Stuttgart (DE); Simon Hackenbroich, Stuttgart (DE); Melanie Nemec, Wolfsburg (DE); Philip Lemmink, Wolfsburg (DE)

(21) Appl. No.: 19/629,931

(22) Filed: Mar. 26, 2026

(30) Foreign Application Priority Data
Mar. 28, 2025 (DE) 10 2025 112 268.7

(51) Int. Cl. G06T 7/80; G06T 7/50; G06T 7/60

(52) U.S. Cl. CPC G06T 7/80; G06T 7/50; G06T 7/60; G06T 2207/30252

(57) ABSTRACT

A method is for calibrating a camera system for a motor vehicle. The camera system includes at least one camera. A target object includes a known arrangement of circular markers arranged in multiple rows and columns of a marker grid. A digital image of the target object is captured using the camera. Correction values for calibration of the camera are determined according to image analysis as a function of the captured image and the known arrangement of the markers. The method includes examining the image for the presence of circular marker candidates and determining the closest neighboring markers to the captured marker candidates in the image. The method further includes determining vertical and horizontal axes of a marker candidate grid as a function of the determined neighboring markers, and identifying the marker candidates as a function of their position in the marker candidate grid.

This application claims priority under 35 U.S.C. § 119 to patent application no. DE 10 2025 112 268.7, filed on Mar. 28, 2025 in Germany, the disclosure of which is incorporated herein by reference in its entirety.

The disclosure relates to a method for calibrating a camera system for a motor vehicle, wherein the camera system comprises at least one camera with a target object comprising a known arrangement of circular markers, which are evenly distributed in multiple rows and columns of a marker grid, wherein a digital image of the target object is captured by means of the camera, and wherein correction values for calibrating the camera are determined by means of image analysis as a function of the captured image and the known arrangement of the markers.

Furthermore, the disclosure relates to a device for operating a camera system for a motor vehicle that comprises at least one camera, with a control unit specifically adapted to perform the above-mentioned method.

Furthermore, the disclosure relates to a camera system having at least one camera and such a device.

### BACKGROUND

Camera calibration is a typical component in the manufacture and provision of a camera system, in particular for a motor vehicle, to ensure that the camera system provides safe and advantageous image analysis while in operation. Most computer vision applications require precise calibration of the intrinsic and extrinsic parameters of the cameras involved. Typically, the calibration is performed before the particular camera is actually deployed in service. This is referred to as offline calibration. However, even during operation, it is advantageous to recalibrate a camera in order to counteract the degeneration of isolated parameters caused over time and to be able to detect camera problems particularly early. For this purpose, a so-called online calibration is carried out during operation. During the calibration process, it is common for a specially prepared target object, whose design and in particular arrangement is known, to be captured by the camera, wherein the target object is detected in the image of the camera by means of an analysis method, in particular an image analysis method, and then used to determine the camera parameters and, if necessary, correction values necessary for calibration. Known target objects are checkerboard patterns, coded markers, or matrix-or grid-shaped circular markers.

In the use of circular markers, it is known to first capture the midpoints of the individual circular shapes, in order to then deconstruct them into histograms to extract the grid structure of the markers. Using the captured grid structure, the potentially matching markers can be uniquely identified based on their location in the grid and mapped to the expected marker positions in the grid structure. Extrinsic and intrinsic parameters of the camera can then be determined, for example, by comparing the detected marker positions in the image with the associated expected marker positions of the grid structure. To capture the midpoints of the markers, it is also known to perform a so-called template matching or a template comparison, which is however very strongly dependent on the size of the circular markers in the image and is therefore not scale-invariant. This makes capturing the matrix arrangement particularly sensitive to small changes in the scene contained in the image, such as a greater distance to the target object or perspective distortion due to an altered angle of rotation. In addition, the template comparison as well as the histogram method require a fine adjustment for each individual case with regard to the size of the markers, the number of markers as well as the color of the markers.

The calibration of a camera typically requires many manual steps necessary in preparation for calibration, for example, the orientation of the target object relative to the camera in relation to position and orientation, in particular with regard to the possible angles of rotation, whereby the known methods in particular also have to comply with the “correct” distance between the target object and the camera. The time required for manual preparations and adjustments largely depends on the sensitivity of the image recognition method employed, because the known methods may react with different sensitivity to changes in the scene. For example, known methods require an angular deviation of less than 1° and a translational deviation of less than 5 cm between the target object and the camera to ensure successful image analysis compared to optimal orientation and positioning. Highly specific analysis methods with a low detection tolerance increase both the time for calibration and preparation as well as the cost of performing the process.

### SUMMARY

The disclosure has the advantage that template matching and histograms are entirely omitted, wherein the target object with a marker grid is nonetheless able to calibrate with high accuracy regardless of the color and size of the markers, matrix size and/or distance between the camera and the target object. The method according to the disclosure is characterized by the following steps:
Step a): First, circular marker candidates are determined in an image captured by the camera.
Step b): Subsequently, for one or more, in particular for each, of the captured marker candidates in the image, the respective nearest neighboring markers are determined from the determined marker candidates.
Step c): Then, vertical and horizontal axes of a marker candidate grid are determined as a function of the determined neighboring markers.
Step d): All captured marker candidates are identified as a function of their position in the marker candidate grid.
Step e): The determined marker candidate grid with the identified marker candidates is compared to the known marker grid and the markers of the target object to determine correction values for camera calibration.

According to a preferred further development of the disclosure, image gradients in the image are determined to perform step a). For this purpose, a gradient to the adjacent pixel is determined for each pixel of the image, thereby generating a gradient or edge image. In particular, a Sobel filter and a Canny edge detector are used for this purpose. Determining the image gradients provides an advantageous basis for analyzing the captured marker candidates.

Preferably, edge pixels are determined as a function of the determined image gradients. These edge pixels are in particular characterized by a high gradient compared to adjacent pixels in terms of color and/or brightness. The edge pixels thus reflect the contour of objects captured in the image. With respect to the target object, the result is that by capturing the image gradients and the edge pixels, the circular contours of the marker candidates are worked out from the captured image, independent of the color and/or the brightness of the marker candidates of the target object detected in the image. Thus, in particular, further determination of the marker candidate grid is independent of marker colors and marker brightness.

Preferably, edge pixels that are juxtaposed in an annular manner in a closed circular shape, i.e., forming an edge pixel ring, are selected as marker candidates. Thus, in particular, all closed ring shapes of edge pixels are first qualified as potential markers of the target object. In the context of the disclosure, an edge pixel ring is in particular defined as a juxtaposition of adjacent edge pixels, wherein two edge pixels are deemed adjacent when they are in their respective Moore neighborhood. The edge pixel contour is considered annular, or a closed contour, when the first and last pixels in the series of edge pixels are also adjacent to each other and within the respective Moore neighborhood. Preferably, all captured edge pixel rings are selected or classified as marker candidates.

In particular, the ratio of the perimeter to the area of the respective ring of edge pixels is determined to capture the circular shape. A circular contour is a contour that is equal to or corresponds to a circular shape, that is, a circular contour may be both a circle and, for example, an ellipse. The circularity as such is preferably determined by the ratio of the circumference to the area of the detected marker shape. This ratio is maximum for a circle and decreases for other shapes that deviate from the circular shape, for example, approaching an oval shape. By adjusting the circle criterion of the contours, the method preferably takes perspective and/or intrinsic distortions of the markers into account in an advantageous manner.

Preferably, in step c), a maximum of four neighboring markers are determined that are closest to the marker candidate. First, the four closest neighboring markers of each marker candidate are determined so that the actual neighbors of the marker candidate are captured, regardless of their arrangement in a detectable grid. In particular, the neighboring markers are selected as a function of a distance criterion, for example as a function of the Euclidean distance.

Of the captured closest neighboring markers, preferably only those that lie on imaginary lines aligned perpendicularly to each other that intersect in the selected marker candidate are selected. For this purpose, in particular, it is checked for each neighboring marker of a marker candidate whether a further neighboring marker of the marker candidate exists, for which the delta vectors between the marker candidate and the neighboring marker are aligned perpendicularly to each other. Additionally, distance limits are preferably imposed so that preferably only neighboring markers are accepted that match the distance relationships of the other neighboring markers. This procedure results in a matrix-shaped neighborhood of markers. Preferably, the lines or delta vectors are used as vertical and horizontal axes of the marker candidate matrix.

Depending on the determined marker candidate grid with the uniquely identified marker candidates and the known marker grid with the known markers of the target object, the correction values for calibration of the camera are then determined or calculated in an advantageous manner by known image comparison methods or calibration methods.

Preferably, only neighboring markers located on at least one of the lines are selected that have the same distance to the marker candidates, to be considered in the further steps of the method. This ensures that a regular matrix pattern is created and taken into account.

Preferably, in step c), the vertical and horizontal axes are selected as a function of the imaginary lines or the delta vectors mentioned above.

Furthermore, it is preferably provided that, in step c), the vertical and horizontal axes are determined by calculating a covariance matrix and determining its eigenvectors (principal component analysis, PCA).

The device according to the disclosure is characterized in that the control unit is specifically configured to execute the method according to the disclosure when used as intended. The advantages specified above are achieved as a result.

The camera system is characterized by the device according to the disclosure. The advantages specified above are achieved as a result.

### BRIEF DESCRIPTION OF THE DRAWINGS

Further advantages and preferred features and combinations of features result in particular from the previous descriptions and from the claims. The disclosure will be explained in more detail below with reference to the drawing. Shown are:

FIG. 1 shows a motor vehicle with a camera system in a test arrangement,

FIGS. 2A and 2B show two exemplary target objects for the test arrangement,

FIGS. 3A, 3B, 3C, 3D, 3E, and 3F show different test situations of the target objects,

FIGS. 4, 5, 6, and 7 show method steps for explaining an advantageous method for calibrating the camera system, and

FIGS. 8A and 8B show exemplary results of the method.

### DETAILED DESCRIPTION

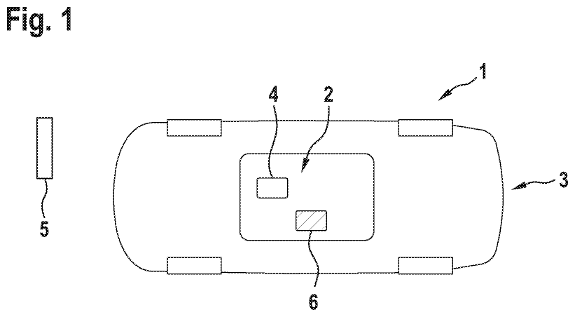

FIG. 1 shows, in a simplified top view, an advantageous test arrangement 1 for calibrating the camera system 2 of a motor vehicle 3. The motor vehicle 3 is positioned in the space such that a camera 4 of the camera system 2 can capture a target object (target) 5 located in the space. According to the present exemplary embodiment, the target object 5 is configured as a display board, on which a plurality of markers are displayed, in particular plotted, in a predetermined arrangement and size.

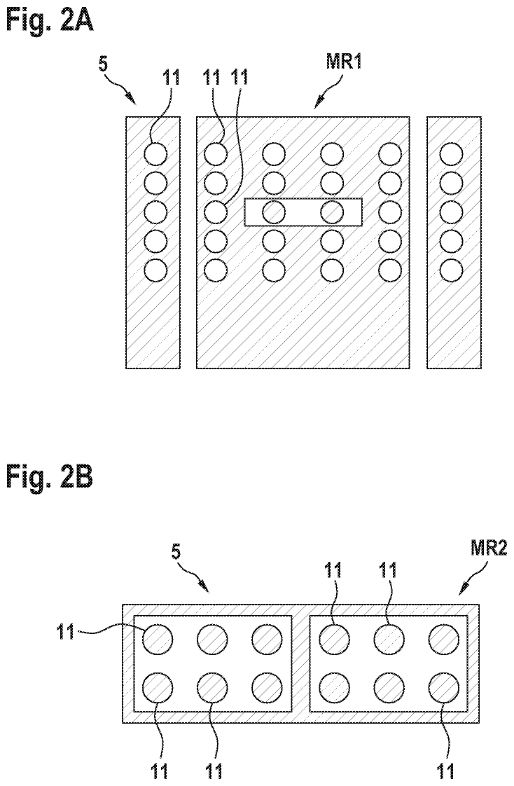

FIGS. 2A and 2B show exemplary embodiments of the target object 5, each in a digital image captured, and in particular saved, by the camera 4.

According to the present exemplary embodiment, markers M, only a few of which are provided with reference numerals in FIGS. 2A and 2B in order to maintain clarity, are configured as circle markers and are each arranged in a predetermined marker grid MR on the front side of the target object. Each marker M is a circular surface formed on the target object 5, which differs, for example, in color or in its brightness from the background of the target object 5. According to the exemplary embodiment of FIG. 2A, the markers are substantially configured as white circular surfaces on a black background, wherein only two markers are configured as black circular surfaces on a common rectangular-shaped white background. According to the exemplary embodiment of FIG. 2B, the markers M are configured as black circular surfaces. In both cases, areas of markers are separated from each other by horizontal strips having the color of the marker surfaces. In the exemplary embodiment of FIG. 2A, a marker grid MR1 of 5×6 circular markers M is shown or formed. In the case of FIG. 2B, a marker grid MR2 of 2×6 circular markers M is formed.

Such target objects are known in the automotive industry and are already used in manufacturing facilities and workshops to calibrate and test cameras and camera systems.

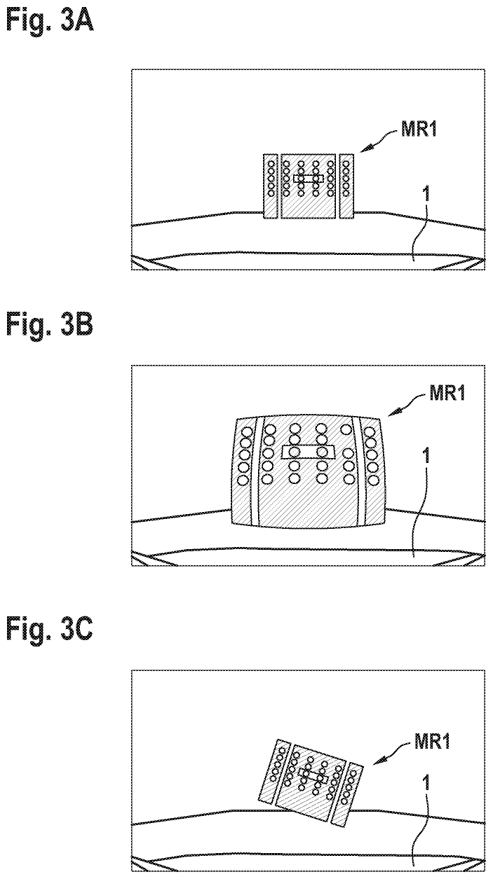

FIGS. 3A, 3B, 3C, 3D, 3E, and 3F each show an image captured by the camera 4 that is used for calibration of the camera system 2. The respective target object 5 located in the image serves for this purpose. FIGS. 3A to 3C show application examples with the target object of FIG. 2A, and FIGS. 3D to 3F show application examples with the target object 5 of FIG. 2B.

According to FIG. 3A to C, the target object 5 is vertically positioned in the space and faces the motor vehicle and its camera 4. According to FIG. 3A, it is at a certain distance from the motor vehicle without particular distortion in the optics of the camera 4. According to FIG. 3B, a fisheye lens of the camera 4 results in distortions in the image that make the target object 5 appear curved in the space. According to the exemplary embodiment of FIG. 3C, the target object 5 has a rotated orientation in the space.

According to the exemplary embodiment of FIG. 3D, the target object 5 lies on the ground in front of the motor vehicle 3 in the detection range of the camera 4, whereby a certain distortion of the target object 5 results in the image due to the fisheye optics. FIG. 3E shows the target object 5, which is located even closer to the motor vehicle 3, resulting in an even greater distortion of the target object 5 in the captured image of the camera 4. In the exemplary embodiment of FIG. 3F, in addition, the target object 5 is rotated about a vertical axis such that a skewed position of the target object 5 in the image of the camera 4 is added to the distortion.

The camera system 2 or the motor vehicle 3 also comprise an advantageous control unit 6, which is configured, when used as intended, to perform the method for calibration of the camera 4 or the camera system 2 described below. The method is characterized by four essential steps, which are explained in more detail below:
Step a) The respective captured image is examined for the presence of circular marker candidates. Thus, it is checked whether elements are included in the image that could represent a marker M of the target object 5.
Step b) Then, the closest neighboring markers in the image are determined for the respective captured marker candidates. The markers adjacent to each respective marker candidate, i.e., representing neighboring marker candidates, are thus determined.
Step c) As a function of the captured marker candidates and the associated neighboring markers, vertical and horizontal axes and a marker candidate grid of the captured marker candidates and neighboring markers are determined. The position and location of the marker candidates and the neighboring markers relative to each other determine whether a marker grid is obtained that shows a regular distribution of marker candidates on the target object.
If this is the case, in a following step d), each marker candidate is uniquely identified based on its position and location in the grid.
Step e) Then, the captured marker candidate grid with the identified marker candidates and the known marker grid with the known markers of the target object 5 are compared with each other, in particular by means of image analysis or a computer vision algorithm. In this image analysis, the grid structure, and thus the position and arrangement of the marker candidates, as well as the size of the marker candidates, are compared with those of the known markers in order to thereby determine distortions in the image of the camera 4 as well as its orientation and position relative to the target object 5.

In particular, it is assumed that the actual position of the target object 5 relative to the motor vehicle 3 is known and that, for example, in the test arrangement 1, it has been precisely adjusted and/or measured before performing the calibration. In particular, the three-dimensional positions relative to the camera are measured or known from the markers M on the target object 5 in the test arrangement.

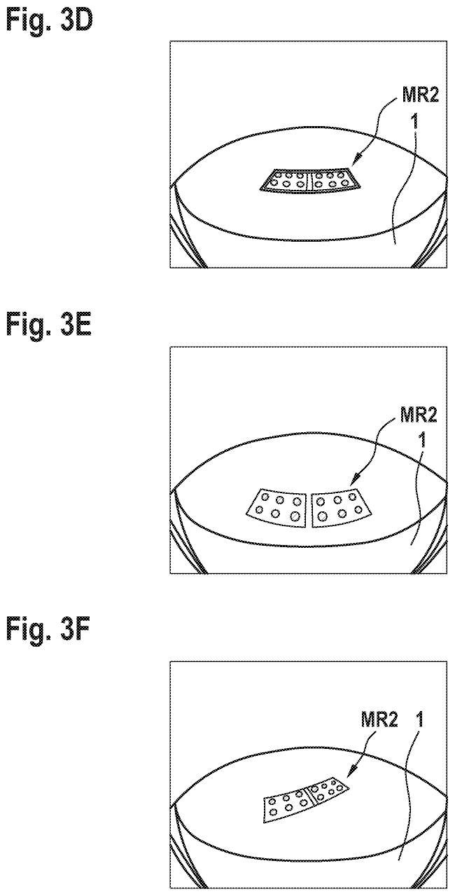

In order to determine the presence of circular marker candidates MK in step a), the advantageous method provides that, as a function of the captured image, image gradients of the captured image, in particular in the area of the determined target object 5, are first calculated and presented, for example with a Sobel filter and a Canny edge detector. An edge image of at least the target object 5 is thus produced, for example as shown in FIG. 4. The circular transitions of the marker candidates MK to the background as edge pixels are worked out by means of the gradients, so that only the contours of the marker candidates MK remain in the gradient image.

Based on this edge image, the control unit 6 subsequently determines closed ring contours, which each represent one of the marker candidates MK. In this context, a contour is understood to be a juxtaposition of adjacent edge pixels, wherein two edge pixel rings are understood to be adjacent when they lie in the Moore neighborhood of the respective other edge pixel. In order for the contour to be recognized as a closed ring contour, it is checked whether the first and the last pixels in the sequence of the edge pixels are also in the Moore neighborhood of the other pixel.

Finally, it is checked whether the respective contour is a circular contour. The circularity of the respective contour is preferably calculated as a function of the ratio of the circumference of the ring contour to the contour area. For a circle, the ratio is maximum and decreases with respect to other shapes, for example an ellipse, the more the contour deviates from the circular shape. By adjusting the circle criterion of the contours, it is also possible for the control unit 6 to advantageously process perspective or intrinsic distortions of the marker candidates MK.

FIG. 4 shows the ring contours obtained by this procedure, each of which represents a marker candidate MK. Preferably, the marker candidates are presented in different colors to facilitate differentiation of adjacent markers.

In the following step, up to four neighboring markers NM, i.e., ultimately neighboring marker candidates, lying adjacent to a selected marker candidate MK, are determined by the control unit 6 for each of the marker candidates detected according to FIG. 4. To this end, preferably firstly, the four neighboring markers NM that are closest to the marker candidate MK are determined as a function of a distance metric, for example a Euclidean distance. The neighboring markers NM are selected independently of their arrangement in a potential marker grid.

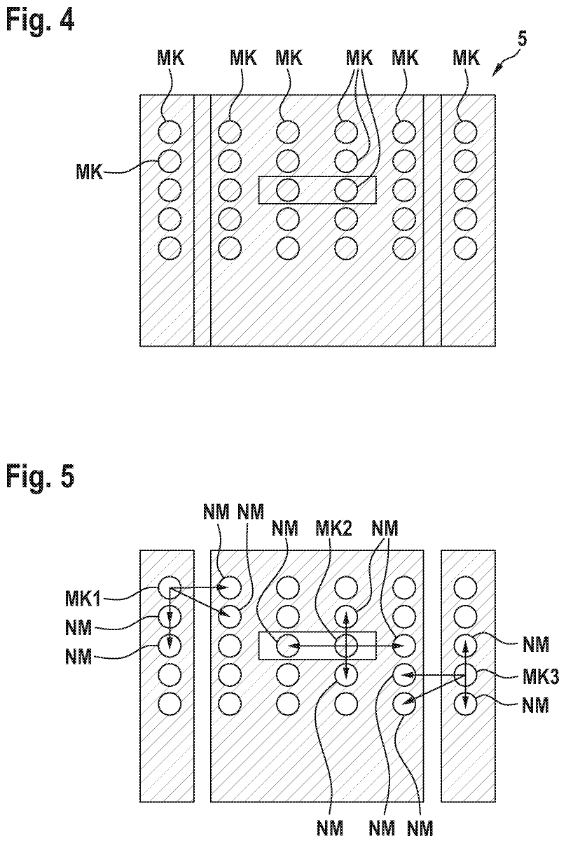

FIG. 5 shows the further procedure simplified based on three selected marker candidates MK1, MK2 and MK3. Based on these, the adjacent and/or the closest marker candidates MK are respectively determined as the neighboring marker NM, as visualized by arrows originating from the respective marker candidate MK1 to MK3.

Preferably, for each neighboring marker NM of the respective marker candidate MK1 to MK3, it is checked whether there is a further neighboring marker NM for that marker candidate MK, for which the delta vectors lie orthogonal to each other between marker candidates and the neighboring marker. In other words, it is checked whether the neighboring markers lie on imaginary lines aligned perpendicularly to each other that intersect in the selected marker candidates MK1 to MK3. Only if this criterion is met will these neighboring markers NM be selected and considered for further steps of the method.

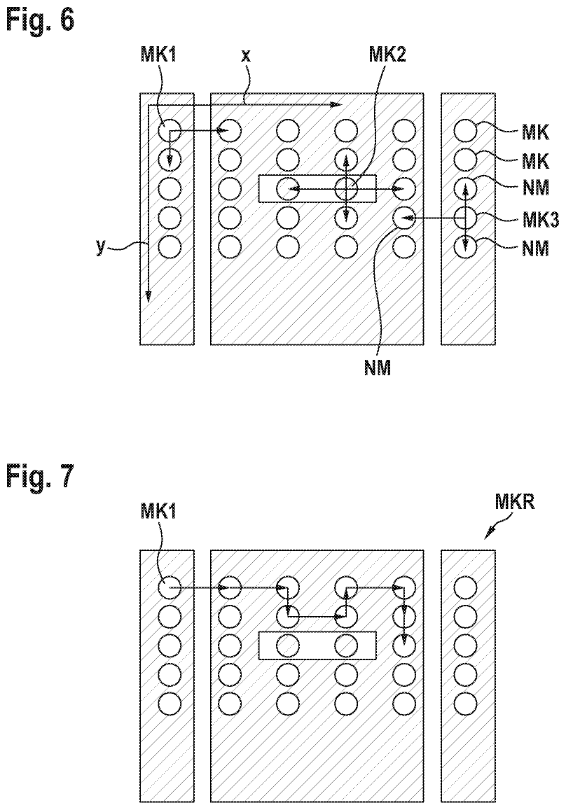

Additionally, a distance constraint is preferably taken into account so that only neighboring markers NM are selected, or accepted for further steps of the method, that have a comparable distance to the marker candidate MK on the same line. This results in a grid-like or matrix-shaped selection of marker candidates and their associated neighboring markers NM having a regular distribution, as exemplified in FIG. 6. In this way, a marker candidate grid MKR is determined.

It should be pointed out at this point that the neighboring markers NM can of course themselves also be marker candidates MK in a further process to determine their respective neighboring markers NM.

Based on the marker candidate grid MKR and/or on the basis of neighborhood relationships of the selected marker candidates in MK1 to MK3, the dominant axes aligned in the vertical and horizontal directions are then determined. For example, the axes are determined by calculating a 2×2 covariance matrix of the delta vectors between each marker candidate MK and its associated neighboring markers NM on the determined marker candidate grid MKR to subsequently deconstruct the matrix into its eigenvectors (principal component analysis, PCA). In the exemplary embodiment of the present target object 5, the eigenvector with the higher eigenvalue then points in the horizontal direction, because the marker candidates MK are farther apart in the horizontal direction than in the vertical direction. The other eigenvector then correspondingly points in the vertical direction of the marker candidate grid MKR, as exemplified by the dominant axes x and y drawn in FIG. 6.

The axes x, y are hereinafter used to generate a coordinate system within the image for the marker candidate grid MKR. In the present case, the marker candidate MK1 at the top left is identified as the marker candidate closest to the origin of the matrix coordinate system. In particular, a graph traversal algorithm, such as a depth-first or breadth-first search algorithm, is employed to link the marker candidates MK to each other and determine the marker candidate grid MKR. In particular, the marker candidates lying on the marker candidate grid MKR are then identified as markers M of the captured target object 5.

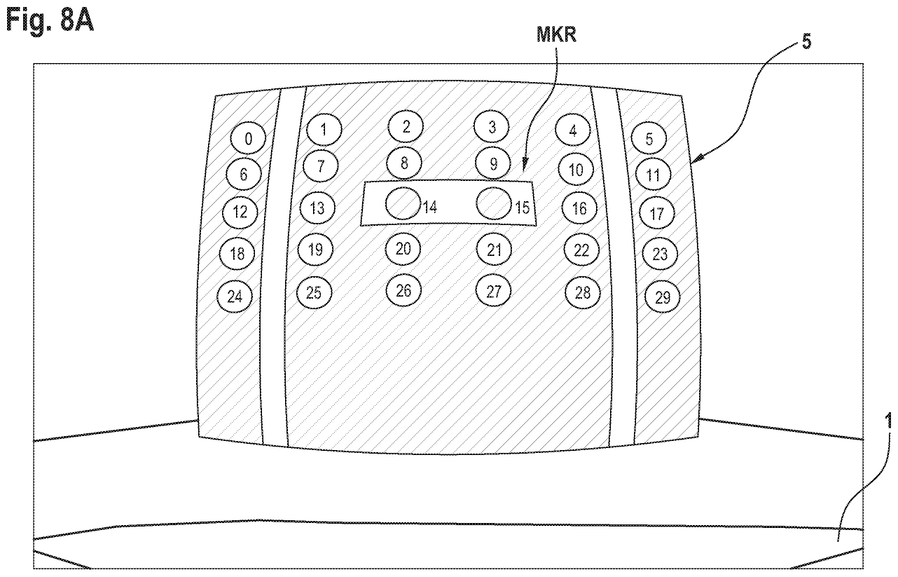

Each marker candidate MK is assigned a row and a column within the marker candidate grid MKR so that it can be uniquely identified. Preferably, for each marker candidate MK, a neighboring NM is sought and its grid position is determined based on the direction of traversal (horizontal or vertical). This process is shown by way of example in FIG. 7.

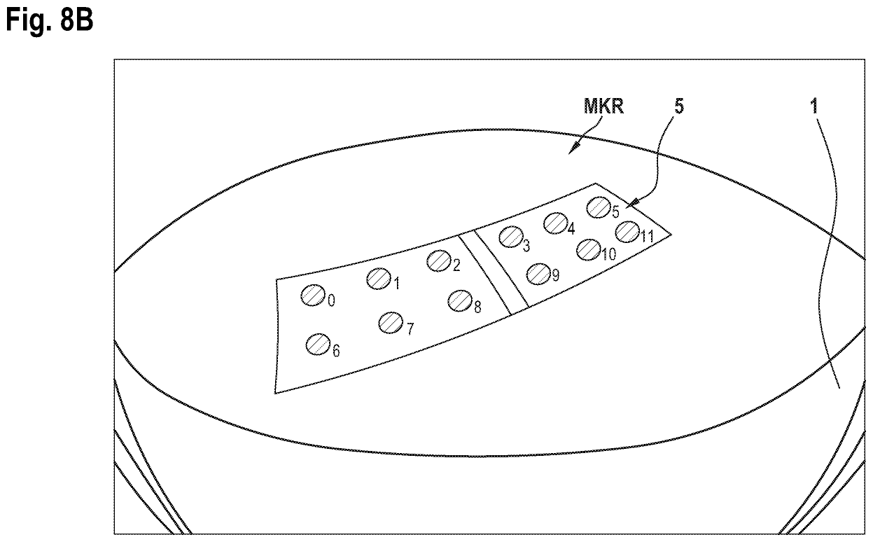

As shown in FIGS. 8A and 8B, the result shows that regardless of the alignment and orientation of the target objects 5 in the space relative to the motor vehicle 3 or the camera 4, the established markers can be clearly determined and identified in the image. FIG. 8A shows the exemplary embodiment of FIG. 3B with identified/marked markers for this purpose, and FIG. 8B shows the exemplary embodiment of FIG. 3F with now identified/marked markers.

As a function of the markers of the MKR marker candidate grid identified in the image of the camera 4, they are compared with the known markers or with the known marker grid MR of the target object 5 in order to check the intrinsic and/or extrinsic parameters of the camera 4 and, if necessary, calibrate it by determining correction values.

The procedure described is completely scale-invariant. It has the advantage that it reliably detects a target object 5 with circular markers, regardless of the scale of the markers in the image, i.e., particularly regardless of the distance of the target object 5 to the camera 4, without the need to adjust the parameterization of the method.

In addition, the method is robust in the face of perspective distortion, since no strict shape assumptions need be made for the markers, as would be the case for template matching, for example. As a result, the advantageous method reliably detects the target object 5 even when it is tilted, rolled, or rotated in a different direction. These advantages allow for a high tolerance for deviations of an actual position and orientation of the target object 5 from a desired position relative to the motor vehicle 3 in the test arrangement, which saves a lot of time during the usual camera calibration tasks, for example in production plants or auto repair workshops, and thereby leads to rapid and reliable calibration of the camera 4.

Moreover, the method is flexible with respect to the definition and configuration of the target object 5. In particular, the method reliably captures any target object having a grid structure of circular markers. It is irrelevant whether the target object 5 is designed with color or is colorless. As long as there is a minimum contrast between the markers and their background, the method allows for a reliable analysis and calibration. In addition, the number of rows and/or columns of the marker grid MR can also be freely selected, as well as the distance that the individual markers M must maintain from one another. This results in high flexibility in the design of the target object. The proposed method can therefore work with a plurality of already existing and regularly used target objects, which simplifies the implementation of the method and also makes it cost-efficient to provide corresponding test arrangements.

The method may work with synthetic, real, or any image data from any image data source and works with monochrome, colored, or otherwise encoded image data. The method allows handling of single or multiple target objects within the same image.

Taken together, the core aspects of the advantageous method according to an exemplary embodiment are the following: First, an image in the test arrangement is captured by the camera 4. Then, image gradients of that image are determined and a gradient image is generated. Then, edge pixels are calculated based on the image gradients and/or the gradient image.

Closed circular ring contours of the edge pixels are then captured as marker candidates.

The closest neighboring marker is then determined for each marker candidate.

Then, horizontal and vertical axes of the marker grid are calculated from these neighboring relationships of marker candidates to neighboring markers.

Then, each marker candidate will be assigned its row and column in the marker grid for its identification and will be identified as a marker of the target object in a marker grid.

Each identified marker in the image of the camera 4 thus receives a unique identification and position, on the basis of which, in a subsequent comparison with the expected image of the target object 5, the parameters of the camera 4 to be calibrated are determined and, in particular, correction values for the calibration of the camera 4 are calculated. These correction values are used in the subsequent operation of the camera system 2 to ensure optimal image analysis.

What is claimed is:

1. A method for calibrating a camera system for a motor vehicle, wherein the camera system comprises at least one camera, and wherein a target object comprises a known arrangement of circular markers arranged in multiple rows and columns of a marker grid, the method comprising:
capturing a digital image of the target object using the at least one camera as a captured image;
determining correction values for calibration of the at least one camera based on image analysis as a function of the captured image and the known arrangement of the circular markers;
examining the captured image for a presence of a plurality of captured circular marker candidates;
determining closest neighboring markers to at least two captured circular marker candidates of the plurality of captured circular marker candidates in the captured image;
determining a vertical axis and a horizontal axis of a marker candidate grid as a function of the closest neighboring markers;
identifying the plurality of captured circular marker candidates as a function of corresponding positions of the at least two captured circular marker candidates in the marker candidate grid; and
comparing the marker candidate grid with the marker grid of the target object to determine the correction values.

2. The method according to claim 1, wherein examining the captured image includes determining image gradients in the captured image.

3. The method according to claim 2, wherein a plurality of edge pixels are captured as a function of the image gradients.

4. The method according to claim 3, wherein:
annular edge pixels of the plurality of edge pixels are annularly arranged in a closed circular shape, and
the annular edge pixels are selected as the plurality of captured circular marker candidates.

5. The method according to claim 4, wherein a circular shape is determined as a function of a ratio of a perimeter to an area of a respective edge pixel ring formed by the annular edge pixels.

6. The method according to claim 1, wherein determining the vertical axis and the horizontal axis includes determining a maximum of four closest neighboring markers that are closest to the at least two captured circular marker candidates.

7. The method according to claim 6, wherein only the closest neighboring markers that lie on imaginary lines aligned perpendicularly to each other that intersect in a selected circular marker candidate of the at least two captured circular marker candidates are selected as the four closest neighboring markers.

8. The method according to claim 7, wherein only the closest neighboring markers located on at least one of the imaginary lines are selected that have a same distance to the selected circular marker candidate.

9. The method according to claim 7, wherein determining the vertical axis and the horizontal axis includes selecting the vertical axis and the horizontal axis as a function of the imaginary lines.

10. The method according to claim 1, wherein determining the vertical axis and the horizontal axis includes determining the vertical axis and the horizontal axis by calculating a covariance matrix and determining eigenvectors of the covariance matrix.

11. A device for operating a camera system for a motor vehicle, the camera system including at least one camera, the device comprising:
a processor operably connected to the at least one camera, the processor configured to perform the method according to claim 1.

12. A camera system, comprising:
at least one camera; and
a device according to claim 11.
